(19) United States
(12) Patent Application Publication
(10) Pub. No.: US 2013/0002777 A1
(43) Pub. Date: Jan. 3, 2013

(54) INK JET RECORDING APPARATUS AND RECORDED ARTICLE

(75) Inventors: Takeshi Yano, Shiojiri (JP); Tetsuya Aoyama, Shiojiri (JP); Shoki Kasahara, Shiojiri (JP)

(73) Assignee: Seiko Epson Corporation, Tokyo (JP)

(21) Appl. No.: 13/535,753

(22) Filed: Jun. 28, 2012

(30) Foreign Application Priority Data
Jun. 29, 2011 (JP) 2011-143847

(51) Int. Cl. B41J 2/01

(52) U.S. Cl. 347/102; 347/105

(57) ABSTRACT

An ink jet recording apparatus includes a first line head that ejects a polymerizable ink containing an active energy radiation-polymerizable compound but substantially not containing a coloring agent onto a recording medium to form an undercoat layer, a second line head that ejects a glittering ink onto the undercoat layer to form a glittering image, a third line head that ejects a coloring ink to form a color image, a transport mechanism that transports the recording medium, an irradiation portion that irradiates the undercoat layer with active energy radiation, and a heating portion that dries the glittering ink. The first line head is disposed upstream from the second line head in the recording medium moving direction, and the third line head is disposed downstream from the second line head in the recording medium moving direction.

Priority is claimed under 35 U.S.C. §119 to Japanese Application No. 2011-143847 filed on Jun. 29, 2011, and is hereby incorporated by reference in its entirety.

### BACKGROUND

1. Technical Field

The present invention relates to an ink jet recording apparatus and a recorded article.

2. Related Art

The demand for recorded articles in which glittering images are formed is increasing. In order to record a glittering image, a metal foil may be pressed on a smooth surface of a recording medium, a metal may be deposited on a plastic film by vacuum vapor deposition, or a glittering ink is applied onto a recording medium, followed by pressing. However, the recording process of these methods is complicated, and recording media that can be used are limited. Accordingly, for example, JP-A-2008-174712 proposes a technique for recording glittering images by an ink jet method.

However, if an image is formed by an ink jet method on a recording medium that cannot absorb ink or is significantly inferior in absorbing ink, or on a recording medium having a rough surface (such as cloth, plain paper, or a medium on which coarse particles have been applied), the glittering pigment applied to the recording medium cannot form a sufficiently smooth surface. Consequently, the image cannot exhibit high glitter due to diffused reflection of light. Also, an additional glittering undercoat layer is formed by applying an ink containing a glittering pigment. This makes it difficult to meet the needs for high speed recording and large-size recording.

### SUMMARY

An advantage of some aspects of the invention is to solve at least part of the above issues, and the following embodiments, or applications, of the invention can be provided.

### Application 1

An ink jet recording apparatus is provided which includes a first line head that ejects a polymerizable ink onto a recording medium to form an undercoat layer, a second line head that ejects a glittering ink containing a glittering pigment onto the undercoat layer to form a glittering image, a transport mechanism that transports the recording medium in a moving direction, and an irradiation portion that irradiates an undercoat layer with active energy radiation. The polymerizable ink contains an active energy radiation-polymerizable compound, but substantially does not contain coloring agent. The first line head is disposed upstream from the second line head in the moving direction.

Since the first line head is disposed upstream from the second line head in the moving direction, a smooth undercoat layer can be formed in advance with the polymerizable ink in the region where the glittering image will be formed. Consequently, a highly glittering image (having, for example, a metallic gloss) can be formed. In addition, since the ink jet heads are line heads, the ink jet recording apparatus can perform large-size recording, and can form a high-definition, high-glitter image at a high speed.

### Application 2

The ink jet recording apparatus may further include a third line head that ejects a coloring ink containing a coloring agent to form a color image. The third line head is disposed downstream from the second line head in the moving direction.

Since the third line head is disposed downstream from the first line head and further downstream from the second line head in the moving direction, the image of the coloring ink can be formed on a glittering undercoat layer. Consequently, a high-definition, high-glitter color image (for example, metallic color image) can be formed. Also, since the ink jet heads are line heads, the ink jet recording apparatus can perform large-size recording, and can form a high-definition, high-glitter color image at a high speed.

### Application 3

The ink jet recording apparatus of Application 1 may further include a fourth line head that ejects an undercoat ink containing a pigment having an average particle size of 200 nm or more to form an undercoat image. The fourth line head is disposed upstream from the first line head in the moving direction.

Since the fourth line head is disposed upstream from the first line head in the moving direction, a relatively coarse pigment, having an average particle size of 200 nm or more, is ejected first, and then the undercoat layer of the polymerizable ink is formed on the image of the coarse pigment. Consequently, the undercoat layer can be more smoothly formed. Since the glittering image is thus formed on this smooth undercoat layer, the particles of the glittering pigment can be evenly arranged and, thus, achieve a high gloss (glitter). The ink jet recording apparatus can perform large-size recording and can form a high-definition, high-glitter image at a high speed.

### Application 4

The ink jet recording apparatus of Application 1 may further include a third line head that is disposed downstream from the second line head in the moving direction and ejects a coloring ink containing a coloring agent to form a color image, and a fourth line head that is disposed upstream from the first line head in the moving direction and ejects an undercoat ink containing a pigment having an average particle size of 200 nm or more to form an undercoat image.

In this embodiment, the third line head is disposed downstream from the second line head in the moving direction, and the fourth line head is disposed upstream from the first line head in the moving direction. Consequently, the color image of the coloring ink can be formed on a glittering undercoat layer. Thus, even if a white-type ink containing a relatively coarse white-type pigment is used as the undercoat ink, for example, for enhancing the lightness, a glittering undercoat layer can be formed. Consequently, a high-definition, high-glitter color image (for example, metallic color image) can be formed. Also, since the ink jet heads are line heads, the ink jet recording apparatus can perform large-size recording, and can form a high-definition, high-lightness, high-glitter color image at a high speed.

### Application 5

The ink jet recording apparatus of Application 1 may further include a third line head that is disposed upstream from the first line head in the moving direction and ejects a coloring ink containing a coloring agent to form a color image, and a fourth line head that is disposed downstream from the second line head in the moving direction and ejects an undercoat ink containing a pigment having an average particle size of 200 nm or more to form an undercoat image.

Since the third line head, the first line head, the second line head and the fourth line head are arranged in that order in the moving direction, inks are ejected onto the recording medium in the order of the coloring ink, the polymerizable ink, the glittering ink and the undercoat ink. Accordingly, by using an optically transparent recording medium, a glittering color image that can be viewed from the rear side, that is, the recording medium side, can be formed with a high definition and a high lightness.

### Application 6

The ink jet recording apparatus of Application 1 may further include a third line head that ejects a coloring ink containing a coloring agent to form a color image, and a fourth line head that ejects an undercoat ink containing a pigment having an average particle size of 200 nm or more to form an undercoat image. The third line head and the fourth line head are interchangeable so as to form either a first arrangement in which the third line head is disposed downstream from the second line head and the fourth line head is disposed upstream from the first line head, or a second arrangement in which the third line head is disposed upstream from the first line head and the fourth line head is disposed downstream from the second line head.

Since the third line head and the fourth line head are interchangeable, either of the two arrangements is possible in one apparatus.

### Application 7

The glittering ink may be an aqueous ink or a solvent-based ink.

Since the glittering ink is an aqueous or solvent-based ink, the glittering pigment can be stably dispersed, and consequently, the ink jet recording apparatus can form a superior glittering image.

### Application 8

The ink jet recording apparatus may further include a heating portion. The heating portion is disposed at a position opposing the second line head with the recording medium therebetween or downstream from the second line head in the moving direction.

Since the heating head is disposed at a position opposing the second line head with the recording medium therebetween or downstream from the second line head, the solvent of the glittering ink remaining in the image region can be dried when or after the glittering ink has been ejected. Consequently, the ink jet recording apparatus can form a superior glittering image.

### Application 9

The ink jet recording apparatus may further include at least one third line head that is disposed downstream from the second line head in the moving direction and ejects a coloring ink containing a coloring agent and an active energy radiation-polymerizable compound, and at least one additional irradiation portion that is disposed downstream from the third line head in the moving direction and emits active energy radiation.

In this structure, the irradiation portion disposed downstream in the moving direction can irradiate the coloring ink containing an active energy radiation-polymerizable compound with active energy radiation every time the coloring ink is ejected, and thus cures the coloring ink. The ink jet recording apparatus thus can from a satisfactory image not exhibiting bleeding even when coloring inks are ejected onto one another, and, thus, can provide a more high-glitter image.

### Application 10

The moving speed of the recording medium moved by the transport mechanism may be varied according to the amount of the polymerizable ink or glittering ink ejected.

Since the moving speed of the recording medium moved by the transport mechanism can be varied according to the amount of the polymerizable ink or glittering ink ejected, the time for which an image is formed can be appropriately controlled. For example, when a glittering image is formed, the polymerizable ink for forming the undercoat layer or the glittering ink needs to be sufficiently dried. If a large amount of polymerizable ink or glittering ink is ejected, the polymerizable ink or the glittering ink can be sufficiently cured or dried by reducing the moving speed of the recording medium to increase the amount of active energy radiation or heat. In contrast, if a small amount of polymerizable ink or glittering ink is ejected, the moving speed of the recording medium can be increased to control the image forming time appropriately.

### Application 11

In the ink jet recording apparatus, the irradiation portion may be disposed so that the distance R1 between the first line head and the irradiation portion and the distance R2 between the second line head and the irradiation portion satisfy the relationship R1>R2.

Since the irradiation portion is disposed at a position satisfying the relationship R1>R2, the degree of clogging of nozzles can be reduced in the first line head. More specifically, the polymerizable ink attached to the nozzle portion of the first line head can be cured by reflection or leakage of the active energy radiation emitted from the irradiation portion. However, by disposing the irradiation portion away from the first line head so as to satisfy the relationship R1>R2, the degree of the clogging of nozzles caused by the curing of the polymerizable ink attached to the nozzle portion can be reduced.

### Application 12

Alternatively, the irradiation portion may be disposed so that the distance R1 between the first line head and the irradiation portion and the distance R2 between the second line head and the irradiation portion satisfy the relationship R1<R2.

Since the irradiation portion is disposed at a position satisfying the relationship R1<R2, the degree of clogging of nozzles can be reduced in the second line head. More specifically, the glittering ink attached to the nozzle portion of the second line head may be hardened by heat generated from the irradiation portion. However, by disposing the irradiation portion away from the second line head so as to satisfy the relationship R1<R2, the degree of the clogging of nozzles caused by the hardening of the glittering ink attached to the nozzle portion can be reduced.

### Application 13

A recorded article is provided which is produced with the ink jet recording apparatus.

Since the recorded article is produced with the above-described ink jet recording apparatus, the recorded article can have a large, high-definition, high-glitter image.

### BRIEF DESCRIPTION OF THE DRAWINGS

The invention will be described with reference to the accompanying drawings, wherein like numbers reference like elements.

FIG. 1 is a schematic diagram of an ink jet recording apparatus according to a first embodiment.

FIGS. 2A and 2B are schematic diagrams of ink jet recording apparatuses according to a second embodiment.

FIG. 3 is a schematic diagram of an ink jet recording apparatus according to a third embodiment.

FIG. 4 is a schematic diagram of an ink jet recording apparatus according to a fourth embodiment.

FIG. 5 is a schematic diagram of an ink jet recording apparatus according to a fifth embodiment.

### DESCRIPTION OF EXEMPLARY EMBODIMENTS

Some embodiments of the invention will be described.

### 1. Recording Method

In embodiments of the invention, recording is performed by ejecting an ink from an ink jet recording head to deposit the ink on a recording medium. The recording apparatus of an embodiment of the invention forms dots on a recording medium by ejecting an ink onto the recording medium from the recording head. The ink jet recording apparatus can form high-definition high-glitter color images at a high speed, for example, on ink-non-absorbent or ink-low-absorbent recording media, recording media having an arithmetic average roughness Ra of 20 μm or more, cloth, plain paper, and recording media whose surface has a pigment layer containing a pigment having an average particle size of 200 nm or more. In the description herein, an image refers to visual information that may be a character or a code.

### 1.1. Ink Jet Recording Head

The recording head of the ink jet recording apparatus may perform recording by continuously ejecting ink droplets from nozzles in a strong electric field, for example, between the nozzles and an acceleration electrode disposed in front of the nozzles, and transmitting a printing information signal from a deflection electrode while the droplets are flying. Recording may be performed by electrostatic suction in such a manner that ink droplets are ejected according to the printing information signal without deflecting the ink droplets. Alternatively, an ink may be forcibly ejected by pressurizing the ink with a small pump and mechanically vibrating the nozzles with a quartz resonator. A piezoelectric method may be applied in which ink droplets are ejected for recording by applying a pressure according to the printing information signal. Also, a thermal jet method may be applied in which ink droplets are ejected for recording by heating an ink to bubble with a miniature electrode according to the printing information signal. In embodiments of the invention, the recording head may eject an ink by any one of these techniques, or by any other technique that can eject an ink in the form of droplets to record dots on a recording medium.

### 1.2. Ink Jet Recording Apparatus

The ink jet recording apparatus may include an ink jet recording head, an apparatus body, a transport mechanism, an ink container, an irradiation portion, a heating portion, and a control board.

The ink jet recording head is a line head that can perform high-speed, large-size recording. The line head has substantially the same length as the width of recording media, such as printing paper, and has ejection nozzles aligned in a line. The line head is fixed, and in this state, recording is performed by ejecting an ink onto a moving recording medium. The ink is supplied from the ink container. In the description herein, the line head refers to one of recording heads arranged in the direction in which the recording medium is moved. The line head is preferably fixed, but may be movable for scanning.

The transport mechanism controls the movement of the recording medium in the apparatus body. The ink container contains an ink set including inks capable of full color printing, a polymerizable ink, a glittering ink, and a white-type ink. The irradiation portion has the function of emitting active energy radiation to polymerize and cure the polymerizable ink deposited on the recording medium. The heating portion has the function of drying the ink deposited on the recording medium by heating. The control board controls the ejection of inks, and the transport mechanism, the irradiation portion, the heating portion and the like. Exemplary embodiments of the structure of the ink jet recording apparatus and the ink set will be described later.

### 2. Recording Medium

Examples of the recording medium that can be used for the recording apparatus include surface-treated paper, such as coat paper, art paper, and cast-coated paper, and transparent or opaque resin films, such as vinyl chloride sheets and PET films. However, the recording medium is not limited to these, and may be an ink-non-absorbent or ink-low-absorbent medium, a medium having an arithmetic average roughness Ra of 20 μm or more, cloth, plain paper, or a medium whose surface has a pigment layer containing a pigment having an average particle size (volume basis) of 200 nm or more.

### 2.1. Ink Absorbency

The ink-non-absorbent or ink-low-absorbent recording medium refers to a recording medium having no ink-receiving layer or insufficiently having an ink-receiving layer. More specifically, the ink-non-absorbent or ink-low-absorbent recording medium exhibits an amount of water absorption of 10 mL/m² or less for a period of 30 ms^{1/2} from the beginning of contact with water, measured by Bristow's method. Bristow's method is broadly used for measuring liquid absorption in a short time, and Japan Technical Association of the Pulp and Paper Industry (JAPAN TAPPI) officially adopts this method. Details of this method are specified in Standard No. 51 (Paper and Paperboard Liquid absorption Test Method-Bristow's Method (in Japanese)) of JAPAN TAPPI Paper and Pulp Test Methods edited in 2000 (in Japanese).

### 2.2. Ink-Non-Absorbent Recording Medium

The ink-non-absorbent recording medium may be a plastic film not surface-treated for ink jet recording (substantially not having an ink-receiving layer), a paper sheet or other media coated or bonded with a plastic film, or a glass or metal sheet. The materials of the plastic film include polyvinyl chloride, polyethylene terephthalate, polycarbonate, polystyrene, polyurethane, polyethylene, and polypropylene.

### 2.3. Ink-Low-Absorbent Recording Medium

Examples of the ink-low-absorbent recording medium include coated paper, such as slightly coated paper, art paper, coat paper, matte paper, and cast-coated paper and other book-printing paper. Coated paper is a type of paper whose surface is coated with a coating material to enhance the beauty and smoothness. The coating material contains a pigment, such as talc, pyrophyllite, clay (kaolin), titanium oxide, magnesium carbonate, or calcium carbonate, and an adhesive. The coating material is applied to a paper with a coater in a manufacturing process. The coater may be of on-machine type that is directly connected to a paper machine so that paper making and coating are performed in one operation, or off-machine type in which coating is performed independently of paper making. Coated paper is mainly classified into coated paper for printing by Classification of dynamic statistics of production, the Ministry of Economy, Trade and Industry.

The slightly coated paper refers to a recording paper coated with 12 g/m² or less of coating material. The art paper refers to a high-grade recording paper (fine quality paper or wood free paper) coated with about 40 g/m² of coating material. The coat paper refers to a recording paper coated with about 20 to 40 g/m² of coating material. The cast-coated paper refers to a recording paper prepared by pressing the surface of art paper or coat paper with a machine called cast drum to enhance the gloss and recording efficiency. The amount of coating material mentioned herein is the total amount of coating material applied to both sides of recording paper.

### 2.4. Surface Roughness

Preferably, the surface of the recording medium onto which a glittering ink will be ejected has an arithmetic average roughness Ra of 20 to 100 μm. The arithmetic average roughness can be measured, for example, with a surface roughness meter or an optical interference microscope. For example, a surface profiler P-15 (manufactured by KLA-Tencor) may be used as the surface roughness meter.

Examples of the recording medium having such a rough surface include fine quality paper 55PW8R, Xerox P (manufactured by Fuji Xerox Co., Ltd., arithmetic average roughness Ra=29.2 μm), Plain Design Black Pater (manufactured by Tochiman Co. Ltd., Ra=30.2 μm), Superfine Paper (manufactured by Seiko Epson Corp., Ra=36.6 μm), and B-flute corrugated Board Sheet (manufactured by Rengo Corp., Ra=39.9 μm).

### 2.5. Cloth

The cloth may be made of cotton, hemp, rayon fiber, acetate fiber, silk, sheep wool, nylon fiber, or polyester fiber. A mixture of these materials may be used.

### 2.6. Plain Paper

Plain paper is a type of paper sheets widely used for recording with an ink jet printer, a laser printer, a copy machine, and the like, including commercially available products labeled as “Plain Paper” and paper sheets generally called “plain paper”. In general, the plain paper is mainly made of cellulose fiber and substantially does not have a swelling layer of a urethane resin or a porous layer of inorganic particles, such as silica or alumina. Exemplary plain paper include double-sided high-quality plain paper (recycled) (manufactured by Seiko Epson Corp.), Canon White Plain Paper (manufactured by Canon Inc.), Kassai plain-finished paper (manufactured by Fujifilm Corporation), A4 high-quality plain paper for Brother (manufactured by Brother Industries, Ltd.), and KOKUYO KB paper (multipurpose) (manufactured by Kokuyo Co., Ltd.).

### 2.7. Pigment Layer

The pigment layer mentioned herein contains a pigment having an average particle size of 200 nm or more. The surface of the pigment layer containing such a coarse pigment is not smooth. When recording is performed with a glittering ink, therefore, satisfactory glossiness is not obtained. In embodiments of the invention, however, a good effect can be produced even though the average particle size is as large as 250 nm or more, or 300 nm or more. When recording is performed on the pigment layer with a glittering ink, the pigment layer may be formed on any recording medium. For example, the pigment layer may be formed on a highly smooth and absorbent medium, such as genuine Epson glossy photo paper manufactured by Seiko Epson Corp. The pigment of the pigment layer may be a known cyan, magenta, yellow, or black pigment. Preferably, a white-type pigment is used.

### 3. Ink Set

An ink set used in the above-described ink jet recording apparatus will now be described. The ink set for ink jet recording in embodiments of the invention is used for recording glittering images with an ink jet recording apparatus, and includes at least a polymerizable ink and a glittering ink.

The polymerizable ink and the glittering ink each may be composed of a single type or a plurality of types, and the ink set may include one or more other inks. Other inks of the ink set include color inks (coloring ink), such as inks of cyan, magenta, yellow, light cyan, light magenta, dark yellow, red, green, blue, orange and violet, and black ink and light black ink.

### 3.1. Polymerizable Ink

The polymerizable ink contains a polymerizable compound, such as an active energy radiation-polymerizable monomer, and optionally a polymerization initiator, and is cured by polymerization reaction caused by irradiation with energy radiation. The polymerizable compound substantially does not contain a coloring agent. Such coloring agents include known dyes and pigments disclosed in, for example, U.S. Patent Application Publication Nos. 2010/0086690 and 2005/0235870, and International Publication No. WO 2011/027842. The phrase “substantially does not contain” means, for example, that the ink does not contain 0.1% by mass or more of pigment, more preferably 0.05% or more of pigment, still more preferably 0.01% by mass or more, further preferably 0.005% by mass or more, and most preferably 0.001% by mass or more. The constituents of the polymerizable ink will be described below. The polymerizable ink may be an aqueous ink containing water in an amount of 30% by mass or more, preferably 50% by mass or more.

### 3.1.1. Polymerizable Compound

The polymerizable compound in the polymerizable ink is polymerized to be solidified by the function of a polymerization initiator (described later) when being irradiated with energy radiation, and it is not otherwise limited. For example, various monomers and oligomers having a monofunctional group, a bifunctional group, or a trifunctional or more polyfunctional group can be used.

Such monomers include unsaturated carboxylic acids and their salts and esters, such as (meth)acrylic acid, itaconic acid, crotonic acid, isocrotonic acid, and maleic acid, urethanes, amides and their anhydrides, acrylonitrile, styrene, unsaturated polyesters, unsaturated polyethers, unsaturated polyamides, and unsaturated urethanes. Such oligomers include linear acrylic oligomers and the like produced from the above monomers, epoxy (meth)acrylate, aliphatic urethane (meth)acrylate, aromatic urethane (meth)acrylate, and polyester (meth)acrylate.

Other monofunctional or polyfunctional monomers may be contained, such as an N-vinyl compound. Examples of the N-vinyl compound include N-vinylformamide, N-vinylcarbazole, N-vinylacetamide, N-vinylpyrrolidone, N-vinylcaprolactam, acryloyl morpholine, and derivatives of these N-vinyl compounds.

Among those, (meth)acrylic acid esters or (meth)acrylates are preferred.

Such a (meth)acrylate may be a monofunctional (meth)acrylate, such as isoamyl (meth)acrylate, stearyl (meth)acrylate, lauryl (meth)acrylate, octyl (meth)acrylate, decyl (meth)acrylate, isomyristyl (meth)acrylate, isostearyl (meth)acrylate, 2-ethylhexyl-diglycol (meth)acrylate, 2-hydroxybutyl (meth)acrylate, butoxyethyl (meth)acrylate, ethoxydiethylene glycol (meth)acrylate, methoxydiethylene glycol (meth)acrylate, methoxypolyethylene glycol (meth)acrylate, methoxypropylene glycol (meth)acrylate, phenoxyethyl (meth)acrylate, tetrahydrofurfuryl (meth)acrylate, isobornyl (meth)acrylate, vinyloxyethoxyethyl acrylate, 2-hydroxyethyl (meth)acrylate, 2-hydroxypropyl (meth)acrylate, 2-hydroxy-3-phenoxypropyl (meth)acrylate, flexible lactone-modified (meth)acrylate, t-butylcyclohexyl (meth)acrylate, dicyclopentanyl (meth)acrylate, dicyclopentenyloxyethyl (meth)acrylate, or isobornyl (meth)acrylate.

Bifunctional (meth)acrylates may be used, such as triethylene glycol di(meth)acrylate, tetraethylene glycol di(meth)acrylate, polyethylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethyloltricyclodecane di(meth)acrylate, bisphenol A ethylene oxide adduct di(meth)acrylate, bisphenol A propylene oxide adduct di(meth)acrylate, hydroxypivalic acid neopentyl glycol di(meth)acrylate, and polytetramethylene glycol di(meth)acrylate.

The (meth)acrylate may be a trifunctional or more polyfunctional (meth)acrylate, such as trimethylolpropane tri(meth)acrylate, ethylene oxide-modified trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, glycerinpropoxy tri(meth)acrylate, caprolactone-modified trimethylolpropane tri(meth)acrylate, pentaerythritolethoxy tetra(meth)acrylate, or caprolactam-modified dipentaerythritol hexa(meth)acrylate.

Among these, preferably, monofunctional (meth)acrylates are preferred as the polymerizable compound. Since monofunctional (meth)acrylates have high stretchability when being cured into a coating and have a low viscosity, they can help stable ejection of the ink composition. More preferably, from the viewpoint of increasing the hardness of the coating, a monofunctional (meth)acrylate and a bifunctional (meth)acrylate are used in combination. The above polymerizable compounds may be used singly or in combination.

Preferably, the monofunctional (meth)acrylate has at least one skeleton selected from among aromatic ring skeletons, saturated alicyclic skeletons, and unsaturated alicyclic skeletons. If a monofunctional (meth)acrylate having such a skeleton is used as the polymerizable compound, the viscosity of the ink can be reduced.

Exemplary monofunctional (meth)acrylates having an aromatic ring skeleton include phenoxyethyl (meth)acrylate and 2-hydroxy-3-phenoxypropyl (meth)acrylate. Exemplary monofunctional (meth)acrylates having a saturated alicyclic skeleton include isobornyl (meth)acrylate, t-butylcyclohexyl (meth)acrylate and dicyclopentanyl (meth)acrylate. Monofunctional (meth)acrylates having an unsaturated alicyclic skeleton include dicyclopentenyloxyethyl (meth)acrylate.

Preferably, the polymerizable compound content is 5% by mass or more. For an aqueous polymerizable ink, 5% to 50% by mass of a polymerizable ink is preferably added. For a non-aqueous polymerizable ink, 50% by mass or more, preferably 70% by mass or more, of a polymerizable compound is added. When these conditions are satisfied, a satisfactory polymerizable ink can be produced.

### 3.1.2. Polymerization Initiator

The polymerization initiator in the polymerizable ink produces an active species, such as a radical or a cation, by the energy of active energy radiation, such as UV light, and thus initiates a polymerization of the polymerizable compound. For example, a radical polymerization initiator or a cationic polymerization initiator may be used without particular limitation, and preferably, a photo-radical polymerization initiator is used.

Examples of such a radial polymerization initiator include aromatic ketones, acylphosphine compounds, aromatic onium salt compounds, organic peroxides, thio compounds, hexaaryl biimidazole compounds, ketoxime ester compounds, borate compounds, azinium compounds, metallocene compounds, active ester compounds, compounds having a carbon-halogen bond, and alkylamine compounds.

More specifically, examples of such a radical polymerization initiator include acetophenone, acetophenone benzyl ketal, 1-hydroxycyclohexylphenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyldimethyl ketal, 1-(4-isopropylphenyl)-2-hydroxy-2-methylpropane-1-one, 2-hydroxy-2-methyl-1-phenylpropane-1-one, thioxanthone, diethylthioxanthone, 2-isopropylthioxanthone, 2-chlorothioxanthone, 2-methyl-1-[4-(methylthio)phenyl]-2-morpholino-propane-1-one, bis(2,4,6-trimethylbenzoyl)-phenylphosphine oxide, 2,4,6-trimethylbenzoyldiphenylphosphine oxide, 2,4-diethylthioxanthone, and bis(2,6-dimethoxybenzoyl)-2,4,4-trimethylpentylphosphine oxide.

Commercially available radical polymerization initiators include IRGACURE 651 (2,2-dimethoxy-1,2-diphenylethane-1-one), IRGACURE 184 (1-hydroxycyclohexylphenyl ketone), DAROCUR 1173 (2-hydroxy-2-methyl-1-phenyl-propane-1-one), IRGACURE 2959 (1-[4-(2-hydroxyethoxy)phenyl]-2-hydroxy-2-methyl-1-propane-1-one), IRGACURE 127 (2-hydroxy-1-{4-[4-(2-hydroxy-2-methyl-propionyl)-benzyl]phenyl}-2-methyl-propane-1-one), IRGACURE 907 (2-methyl-1-(4-methylthiophenyl)-2-morpholinopropane-1-one), IRGACURE 369 (2-benzyl-2-dimethylamino-1-(4-morpholinophenyl)-butanone-1), IRGACURE 379 (2-(dimethylamino)-2-[(4-methylphenyl)methyl]-1-[4-(4-morpholinyl)phenyl]-1-butanone), DAROCUR TPO (2,4,6-trimethylbenzoyl-diphenyl-phosphine oxide), IRGACURE 819 (bis(2,4,6-trimethylbenzoyl)phenylphosphine oxide), IRGACURE 784 (bis(2,4-cyclopentadienyl)bis[2,6-difluoro-3-(1H-pyrrole-1-yl)phenyl] titanium(IV)), IRGACURE OXE 01 (1-[4-(Phenylthio)phenyl]-1,2-octanedione 2-(O-benzoyloxime)), IRGACURE OXE 02 (1-[9-ethyl-6-(2-methylbenzoyl)-9H-carbazole-3-yl]ethanone (O-acetyloxime)), and IRGACURE 754 (mixture of 2-[2-oxo-2-phenylacetoxyethoxy]ethyl oxyphenylacetate and 2-[2-hydroxyethoxy]ethyl oxyphenylacetate) (each produced by BASF); DETX-S (2,4-diethylthioxanthone) (produced by Nippon Kayaku); Lucirin TPO, LR8893 and LR8970 (each produced by BASF); and Ubecryl P36 (produced by UCB).

The above polymerization initiators may be used singly or in combination. In an embodiment, the polymerization initiator may be omitted by using an active energy radiation-polymerizable compound as the polymerizable compound. It is however preferable to use a polymerization initiator because the use of a polymerization initiator facilitates the control of the initiation of the polymerization.

### 3.1.3. Water, Solvent

The polymerizable ink may contain water or an organic solvent.

### 3.1.4 Other Constituents

The polymerizable ink may further contain other constituents. For example, a surfactant or a resin component may be contained.

The surfactant may be a silicone surfactant, such as polyester-modified silicone or polyether-modified silicone. More specifically, polyether-modified polydimethyl siloxane or polyester-modified polydimethyl siloxane is preferably used. Examples of such a surfactant include BYK-347, BYK-348, BYK-349, BYK-UV 3500, BYK-UV 3510, BYK-UV 3530, and BYK-UV 3570 (each available from BYK Japan KK).

A polymerization inhibitor may be added. The addition of a polymerization inhibitor enhances the storage stability of the ink composition. For example, a hindered amine-based polymerization inhibitor IRGASTAB UV-10 or a hindered phenol-based polymerization inhibitor IRGASTAB UV-22 (each available from Ciba Inc.) may be used as the polymerization inhibitor.

Furthermore, the polymerizable ink may contain a polymerization promoter, a slipping agent, a penetration enhancer, a wetting agent (moisturizing agent), and other additives. Other additives include a fixing agent, a fungicide, a preservative, an antioxidant, an ultraviolet absorbent, a chelating agent, a pH adjuster, and a thickener.

### 3.2. Glittering Ink

The glittering ink contains a glittering pigment, and may be an aqueous ink containing 50% by mass or more of water, or a non-aqueous ink containing less than 50% by mass of water. The non-aqueous ink may be a solvent-based ink containing 50% by mass or more of an organic solvent. In the following description, the constituents of an aqueous glittering ink will be described as an example of the glittering ink. Any glittering pigment may be added to the glittering ink as long as droplets of the ink can be ejected by an ink jet recording method. The glittering pigment can produce glitter when the glittering ink has been deposited on a coating of a resin ink, or can impart glitter to something on which the glittering ink has been deposited. The glittering pigment may be a pearl pigment or metal particles. Exemplary pearl pigments include pigments exhibiting pearly gloss or interference gloss, such as titanium dioxide-coated mica, fish scale foil, and bismuth trichloride. Metal particles include those of aluminum, silver, gold, platinum, nickel, chromium, tin, zinc, indium, titanium, and copper, and are made of at least one selected from among elemental metals and alloys or mixtures of these metals.

The glittering pigment is preferably made of silver from the viewpoint of glossiness (glitter), or aluminum from the viewpoint of cost efficiency. An aluminum pigment disclosed in U.S. Pat. No. 7,828,888 is preferably used as the pigment of metal particles. A silver ink will be described below as an example of the glittering ink.

### 3.2.1. Silver Particles

The silver ink contains silver particles. If the glittering ink contains silver particles, particularly together with a wax satisfying predetermined conditions, images having good metallic gloss can be formed. In addition, since silver has a higher whiteness than other metals, the silver ink can produce metallic colors, such as gold and copper, by combined use of other color inks.

Preferably, the silver particles have an average particle size in the range of 5 to 100 nm, and more preferably in the range of 20 to 65 nm. Such silver particles can increase the feel of gloss (glitter) and the rub fastness of images formed with the silver ink. Also, the ejection stability (accuracy of landing positions, stability of ejection quantity, etc.) of the ink ejected by an ink jet method can be enhanced, and consequently, images having desired quality can be more reliably formed over a long time. The term “average particle size” mentioned herein is on a volume basis unless otherwise specified. The average particle size can be measured with a particle size distribution analyzer based on a laser diffraction/scattering method. A particle size distribution meter using dynamic light scattering (for example, Microtrack UPA manufactured by Nikkiso Co., Ltd.) may be used as the laser diffraction/scattering particle size distribution analyzer.

The silver particle content in the glittering ink is preferably 0.5% to 30% by mass, and more preferably 5.0% to 15% by mass. Such an ink can be stably ejected by an ink jet method, and can be stably stored. Furthermore, the image of the record article has high quality and high rub fastness in a wide range of density from the case where the silver particle density (silver particle content) on the recording medium of the recorded article is low to the case where it is high.

The silver particles may be prepared in any process. For example, silver ions in a solution can be reduced into silver.

### 3.2.2. Resin

The silver ink may contain a resin. By adding a resin, the fixability and the rub fastness of the ink can be enhanced. Examples of the resin include, but are not limited to, polyacrylic acid, polymethacrylic acid, polymethacrylate ester, polyethylacrylic acid, styrene-butadiene copolymer, polybutadiene, acrylonitrile-butadiene copolymer, chloroprene copolymer, fluororesin, vinylidene fluoride, polyolefin resin, cellulose, styrene-acrylic acid copolymer, styrene-methacrylic acid copolymer, polystyrene, styrene-acrylamide copolymer, polyisobutyl acrylate, polyacrylonitrile, polyvinyl acetate, polyvinyl acetal, polyamide, rosin-based resin, polyethylene, polycarbonate, vinylidene chloride resin, cellulose resins such as cellulose acetate butyrate, vinyl acetate resin, ethylene-vinyl acetate copolymer, vinyl acetate acrylic copolymer, vinyl chloride resin, polyurethane, rosin ester, paraffin wax, polyethylene wax, and carnauba wax.

### 3.2.3. Polymerizable Compound

The glittering ink may contain any of the above-described polymerizable compounds. In other words, the glittering ink may be cured by active energy radiation. It is however preferable that the glittering ink substantially do not contain a polymerizable compound. The phrase “substantially do (does) not contain” means, for example, that the ink does not contain 5% by mass or more of compound, more preferably 1% by mass or more of compound, still more preferably 0.1% by mass or more, further preferably 0.01% by mass or more, and most preferably 0.001% by mass or more.

It is more difficult to use a glittering pigment in a polymerizable ink than to use a known color pigment, such as a cyan or magenta pigment. Since this disadvantage may be solved in the future, the glittering ink used in embodiments of the invention is not limited to an ink substantially not containing an active energy radiation-polymerizable compound. However, the metal pigment disclosed in U.S. Pat. No. 7,828,888 is undesirably oxidized in a polymerizable ink, and is thus difficult to produce high glossiness. In addition, the particles of the metal pigment are not favorably arranged when the polymerizable compound is cured. It is therefore preferable that the glittering ink substantially do not contain a polymerizable compound.

### 3.2.4 Polyhydric Alcohol

Preferably, the glittering ink contains a polyhydric alcohol. In the use of the glittering ink in an ink jet recording apparatus, the polyhydric alcohol hinders the ink from drying and thus prevents the ink from clogging the ink jet recording head.

Exemplary polyhydric alcohols include ethylene glycol, diethylene glycol, triethylene glycol, polyethylene glycol, polypropylene glycol, propylene glycol, butylene glycol, 1,2,6-hexanetriol, thioglycol, hexylene glycol, glycerin, trimethylolethane, trimethylolpropane, 1,2-butanediol, 1,2-pentanediol, 1,2-hexanediol, 1,2-heptanediol, 1,2-octanediol, 1,4-butanediol, 1,5-pentanediol, and 1,6-hexanediol. Among these, alkanediols having a carbon number of 4 to 8 are preferred, and those having a carbon number of 6 to 8 are more preferred. These polyhydric alcohols can enhance the penetration of the glittering ink into the recording medium. The polyhydric alcohol content in the glittering ink is preferably, but is not limited to, 0.1% to 20% by mass, and more preferably 0.5% to 10% by mass.

Preferably, the glittering ink contains 1,2-hexanediol or trimethylolpropane as the polyhydric alcohol. These polyhydric alcohols can particularly enhance the dispersion stability of the silver particles in the glittering ink and the storage stability and ejection stability of the ink.

### 3.2.5. Glycol Ether

Preferably, the glittering ink contains a glycol ether. Glycol ethers can increase the wettability to the recording surface of the recording medium and thus enhance the penetration of the ink. Exemplary glycol ethers include lower alkyl ethers of polyhydric alcohols, such as ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, dipropylene glycol monomethyl ether, dipropylene glycol monoethyl ether, triethylene glycol monomethyl ether, triethylene glycol monobutyl ether, and tripropylene glycol monomethyl ether. In particular, the use of triethylene glycol monobutyl ether leads to higher recording quality. The glycol ether content in the ink is preferably, but is not limited to, 0.2% to 20% by mass, and more preferably 0.3% to 10% by mass.

### 3.2.6. Surfactant

The glittering ink may contain an anionic, nonionic, cationic or amphoteric surfactant. Preferably, the glittering ink contains a fluorochemical surfactant, an acetylene glycol-based surfactant or a polysiloxane-based surfactant. Acetylene glycol-based and polysiloxane-based surfactants can increase the wettability of the recording surface of the recording medium to enhance the penetration of the ink.

Exemplary acetylene glycol-based surfactants include 2,4,7,9-tetramethyl-5-decyne-4,7-diol, 3,6-dimethyl-4-octyne-3,6-diol, 3,5-dimethyl-1-hexyne-3-ol, and 2,4-dimethyl-5-hexyne-3-ol. A commercially available acetylene glycol-based surfactant may be used, such as OLFINEs E1010, STG and Y (each produced by Nissin Chemical Industry); and SURFYNOLs 104, 82, 465, 485 and TG (each produced by Air Products and Chemicals Inc.)

The polysiloxane-based surfactant is commercially available as, for example, BYK-347, BYK-348 or BYK-349 (each produced by BYK). The glittering ink may further contain other anionic, nonionic, or amphoteric surfactants. The surfactant content in the ink is preferably, but is not limited to, 0.01% to 5.0% by mass, more preferably 0.05% to 2.5% by mass, and still more preferably 0.1% to 1.0% by mass.

### 3.2.7 Other Constituents

The glittering ink may contain other constituents. Other constituents include, for example, a pH adjuster, a penetrant, an organic binder, a urea-based compound, a drying inhibitor such as alkanolamine (for example, triethanolamine), and thiourea.

### 3.3. Ink (Undercoat Ink) Containing Pigment Having Average Particle Size of 200 nm or More

The undercoat ink contains a pigment having a mean particle size of 200 nm or more. The pigment may be inorganic or organic. Examples of the pigment include white-type pigments, carbon blacks, azo pigments such as insoluble azo pigments, condensed azo pigments, azo lake, and chelate azo pigments, polycyclic pigments such as phthalocyanine pigments, perylene and perinone pigments, anthraquinone pigments, quinacridone pigments, dioxane pigments, thioindigo pigments, isoindolinone pigments, and quinophthalone pigments, dye chelates, dye lakes, nitro pigments, nitroso pigments, aniline black, and daylight fluorescent pigments. These pigments may be used singly or in combination. Preferably, a white-type pigment is used. The average particle size of the pigment can be measured with a particle size distribution analyzer based on a laser diffraction/scattering method. A particle size distribution meter using dynamic light scattering (for example, Microtrack UPA manufactured by Nikkiso Co., Ltd.) may be used as the particle size distribution analyzer.

The solvent added to the ink may be, but is not limited to, an organic solvent or a surfactant. The same organic solvent or surfactant as in the glittering ink can be used.

### 3.3.1. White-Type Pigment

A white-type pigment mentioned herein refers to a pigment that can produce a color generally called “white”, and may be slightly colored. The pigment contained in a white-type ink or white ink also belongs to the white-type pigment. Also, the pigment contained in an ink that can exhibit a lightness (L*) and chromaticities (a*, b*) satisfying the relationships 70≦L*≦100, −4.5≦a*≦2, and −6≦b*≦2.5 when the ink is used for recording on genuine Epson glossy photo paper (manufactured by Seiko Epson Corp.) belongs to the white-type pigment, wherein the lightness (L*) and the chromaticities (a*, b*) are measured with a spectrophotometer Spectrolino (manufactured by GretagMacbeth) with a D50 light source at an observation viewing angle of 2° according to a DIN NB density standard in a measurement mode of Reflectance (white standard: Abs; No filter).

Examples of the white-type pigment include metal oxide particles of titanium dioxide, zinc oxide, silica, alumina, magnesium oxide, zirconium oxide or the like and hollow particles. Among these, particles of titanium dioxide powder are preferred because of their high whiteness.

If metal oxide particles are used, the average particle size d50 (volume basis) is preferably in the range of 250 to 440 nm. Such a white-type pigment can form a layer having a satisfactory whiteness.

Commercially available titanium dioxide particles may be used, such as ultrafine titanium oxide particles TTO series (produced by Ishihara Sangyo), fine titanium oxide particles (produced by Tayca Corp.), and NanoTek® Slurry (produced by C. I. Kasei, Inc.).

The white-type pigment may include hollow particles. Known hollow particles may be used without particular limitation. For example, particles disclosed in U.S. Pat. No. 4,880,465 are preferably used. Organic hollow particles are commercially available. For example, sx 866 series (produced by JSR, Inc.) may be used. The hollow particles preferably have an average particle size in the range of 300 nm to 1 μm.

The white-type ink may contain other additives as disclosed in the description of the glittering ink.

### 3.4. Coloring Ink

The coloring ink contains a pigment or a dye as a coloring agent. The dyes or pigments disclosed in U.S. Patent Application Publication Nos. 2010/0086690 and 2005/0235870 or International Publication No. WO 2011/027842 can be suitably used in the coloring ink. More preferably, the coloring ink contains a pigment. The pigment is preferably an organic pigment from the viewpoint of storage stability, such as light fastness, weather fastness, and a gas fastness.

Examples of the organic pigment include azo pigments such as insoluble azo pigments, condensed azo pigments, azo lake, and chelate azo pigments, polycyclic pigments such as phthalocyanine pigments, perylene and perinone pigments, anthraquinone pigments, quinacridone pigments, dioxane pigments, thioindigo pigments, isoindolinone pigments, and quinophthalone pigments, dye chelates, dye lakes, nitro pigments, nitroso pigments, aniline black, and daylight fluorescent pigments. These pigments may be used singly or in combination.

The coloring ink may contain other additives as disclosed in the description of the glittering ink.

### 4. Process for Ink Jet Recording

In embodiments of the invention, ink jet recording is performed by ejecting inks of the above-described ink set onto a recording medium, using the above-described ink jet recording apparatus. Process steps of the ink jet recording will be described below.

### 4.1. Undercoat Layer Forming Step

In an undercoat layer forming step, the polymerizable ink is deposited on a predetermined recording medium or pigment layer to form an undercoat layer. The undercoat layer is selectively formed at a desired position for image recording (position on which the glittering ink is to be deposited) by an ink jet recording method. The undercoat layer functions as a glittering ink-receiving layer. The solvent in the glittering ink permeates the undercoat layer, so that the particles of the glittering pigment are evenly oriented on the recording medium. The weight of a droplet of the polymerizable ink is not particularly limited, but is preferably 1 to 20 ng, and the average thickness of the undercoat layer is preferably in the range of 0.1 to 30 μm, more preferably in the range of 1 to 15 μm. Thus, a more high-glitter image can be formed.

### 4.2. Irradiation Step

In an irradiation step, the resulting undercoat layer is cured by being irradiated with active energy radiation. Any active energy radiation may be used as long as it can apply an energy that can generate an initiation species from the polymerization initiator irradiated with the radiation. Exemplary active energy radiation include, but is not limited to, α radiation, γ radiation, X-ray radiation, UV radiation, visible ray radiation, and electron radiation. Among these, the active energy radiation is preferably UV or electron radiation, more preferably UV radiation, from the viewpoint of curing sensitivity and availability of equipment. This step enhances the function of the undercoat layer as an ink-receiving layer and allows the resulting image to have a higher adhesion to the recording medium.

The irradiation of the undercoat layer is performed with a light source of active energy radiation, such as a metal halide lamp, a high-pressure mercury-vapor lamp, or a light emitting diode (LED). Preferably, an LED is used. LEDs can easily vary the irradiation energy by controlling the current applied thereto. The light source for the irradiation of the undercoat layer has a peak wavelength preferably in the range of 350 to 450 nm, more preferably in the range of 380 to 450 nm. The use of an LED having a peak wavelength in such a range can advantageously reduce the cost. The irradiation energy for curing is not particularly limited and depends on the composition of the ink. Preferably, it is in the range of 10,000 mJ/cm² or less, and more preferably 100 to 1,000 mJ/cm².

### 4.3. Recording Step

In the recording step, droplets of the glittering ink are ejected from the ink jet recording apparatus onto the undercoat layer to deposit the glittering ink on the recording medium, thus forming an image on the recording medium. In addition, a coloring ink, a black ink, a light black ink or the like may be ejected, if necessary, for forming an image. A recorded article is thus produced.

The thickness of the image is preferably 0.02 to 10 μm, and more preferably 0.05 to 5 μm. If the thickness of the glittering layer is less than 0.02 μm, the glitter of the record surface may not be satisfactory.

### 4.4. Heating Step

After the formation of the undercoat layer, heating may be performed (with a heating portion) if necessary. Any heating technique can be applied as long as it can accelerate the vaporization of the liquid medium of the ink. For heating, the recording medium may be heated, or air is blown to the ink on the recording medium. These techniques may be combined. More specifically, preferred heating techniques include forcible air heating, heat radiation, conduction heating, high-frequency drying and microwave drying. In the heating step, the surface of the recording medium is heated to a temperature at which the evaporation and dispersion of the liquid medium of the ink can be accelerated. For example, the surface is heated to, but not limited to, 40° C. or more, preferably 40 to 130° C., and more preferably 40 to 110° C. The “temperature” in this case is that of the surface of the recording medium with which the ink comes into contact.

If the heating step is performed in an embodiment, the glittering ink is preferably an aqueous or solvent-based ink substantially not containing an active energy radiation-polymerizable compound. If the glittering ink is an aqueous or solvent-based ink, the aqueous or solvent-based ink is not dried, solidified or cured even by irradiating the polymerizable ink with active energy radiation. In this instance, if the recording speed has priority, the recording medium may be transported in a state where the glittering ink is not fully dried, solidified or cured even though the glittering ink is absorbed into the layer of the polymerizable ink. By performing the heating step, the glittering ink can be favorably dried, solidified or cured, and, thus, the recording apparatus and the recording method can perform more satisfactory recording.

Furthermore, if the heating step is performed, the polymerizable ink can be aqueous. In recent years, aqueous polymerizable inks have been developed from the viewpoint of environmental protection. However, aqueous polymerizable inks may not be sufficiently dried, solidified or cured only by irradiation with active energy radiation. By performing the heating step, the recording apparatus and the recording method can perform more satisfactory recording.

### 5. Example

Some examples of the invention will now be described in detail. However, the examples are not intended to limit the scope of the invention.

### 5.1. Preparation of Inks

### 5.1.1. Preparation of Polymerizable Ink

A polymerizable ink was prepared by mixing photopolymerization initiators, polymerizable compounds, a polymerization inhibitor and a surfactant according to the composition shown in Table 1. In the example, IRGASTAB UV-22 (produced by Ciba) was used as the polymerization inhibitor, and BYK-UV 3500 (produced by BYK) was used as the as the surfactant.

TABLE 1

| Photopolymerization | DETX-S | — |
|---|---|---|
| initiator | IRGACURE 819 | 4 |
| | DAROCUR TPO | 4.8 |
| Polymerizable compound | N-vinylcaprolactam | 15 |
| | Phenoxyethyl acrylate | 15 |
| | tripropylene glycol | 59.1 |
| | diacrylate | |
| Polymerization inhibitor | IRGASTAB UV-22 | 1.6 |
| Surfactant | BYK-UV 3500 | 0.5 |
| | Total | 100 |

### 5.1.2. Preparation of Glittering Ink

A glittering ink was prepared as below. First, polyvinyl pyrrolidone (PVP, weight average molecular weight: 10,000) was heated at 70° C. for 15 hours, and then cooled to room temperature. To 500 mL of ethylene glycol was added 1,000 g of PVP to prepare a PVP solution. To a different vessel containing 500 mL of ethylene glycol was added 128 g of silver nitrate. The mixture was sufficiently stirred with an electromagnetic stirrer to prepare a silver nitrate solution. The silver nitrate solution was added to the PVP solution with stirring with an overhead mixer at 120° C., and the mixture was heated at that temperature for about 80 minutes so that the reaction proceeded. The solution was then cooled to room temperature. The resulting solution was centrifuged at 2200 rpm for 10 minutes. Subsequently, separated silver particles were taken out, and 500 mL of ethanol was added for removing excess of the PVP. Centrifugation was further performed, and silver particles were taken out. Then, the silver particles were dried at 35° C. and 1.3 Pa in a vacuum dryer. The glittering ink was prepared by adding 10% by mass of propylene glycol, 5% by mass of 1,2-hexanediol, 5% by mass of 2-pyrrolidone, 1% by mass of silicone surfactant (BYK-348) and a balance of ion exchanged water to 10% by mass of silver particles.

### 5.1.3. Preparation of White-type Ink

A white-type ink was prepared using 10% by mass of titanium dioxide (volume average particle size: 330 nm, NanoTek® Slurry produced by C.I. Kasei Co., Ltd.), 2% by mass of styrene-acrylic acid copolymer, 5% by mass of 1,2-hexanediol, 10% by mass of glycerin, 0.9% by mass of triethanolamine, 0.5% by mass of BYK-348 (produced by BYK) and a balance of ion-exchanged water.

### 5.2. Structure of Ink Jet Recording Apparatus

Specific embodiments of the ink jet recording apparatus of the invention will now be described with reference to the drawings. However, the following embodiments are not intended to limit the invention. For the sake of easy understanding, the proportions of the sizes in each figure are varied from the actual proportions.

### 5.2.1. First Embodiment

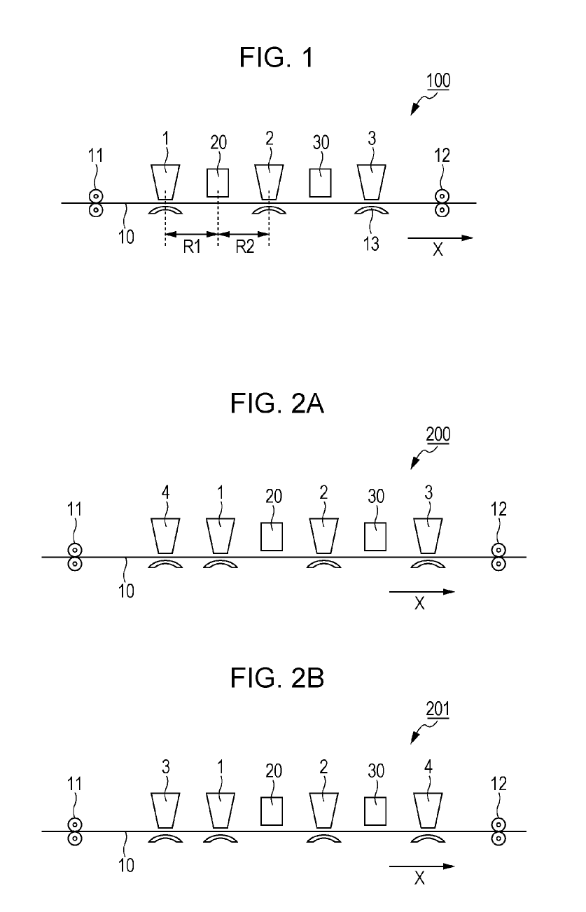

FIG. 1 is a schematic view of an ink jet recording apparatus 100 according to a first embodiment. The ink jet recording apparatus 100 records an image on a recording medium 10 by an ink jet recording method. The ink jet recording apparatus 100 includes a first, a second and a third line head 1 to 3, transport mechanisms 11 and 12, guides 13, an irradiation portion 20, and a heating portion 30. Also, the ink jet recording apparatus 100 further includes a control board and an ink container (each not shown) in an apparatus body.

The recording medium 10, supported on the guides 13, is moved within the apparatus body by the transport mechanisms 11 and 12. One transport mechanism 11 is disposed upstream in the direction in which the recording medium 10 is moved (X direction in FIG. 1, hereinafter referred to as the moving direction of the recording medium), and the other transport mechanism 12 is disposed downstream of the apparatus. However, the position where the transport mechanism is disposed is not limited to these two, upstream and downstream. Also, the movement of the recording medium is not limited to such linear (horizontal) one direction. For example, the transport mechanism may be curved so that the path of transport is curved. Hence, the X direction does not indicate a linear direction, but the direction in which the recording medium moves.

Each of the line heads 1 to 3 has many ejection nozzles aligned in a line in a direction intersecting the X direction. The first to third line heads 1, 2 and 3 are arranged in that order in the direction from the upstream side to the downstream side (X direction), in which the recording medium 10 moves. The first line head 1 ejects a polymerizable ink delivered from the ink container. The second line head 2 ejects a glittering ink delivered from the ink container. The third line head 3 ejects a coloring ink delivered from the ink container.

The irradiation portion 20 is disposed between the first line head 1 and the second line head 2, and emits active energy radiation to the polymerizable ink that has been ejected from the first line head 1. The irradiation portion 20 includes a light emitting diode (for example, UV LED that emits UV light having a wavelength of 395 nm). The position of the irradiation portion 20 is not particularly limited, but is preferably located so that the distance R1 between the first line head 1 and the irradiation portion 20 and the distance R2 between the second line head 2 and the irradiation portion 20 satisfy the relationship R1>R2. In this instance, the irradiation apparatus, or irradiation portion 20, is not necessarily disposed between the first line head 1 and the second line head 2, as long as the polymerizable ink ejected from the first line head 1 can be irradiated with active energy radiation with R1>R2 satisfied.

The heating portion 30 is not always required, but may be disposed between the second line head 2 and the third line head 3 and functions to heat the glittering ink that has been ejected from the second line head 2 to accelerate the evaporation and dispersion of the liquid medium of the glittering ink. The heating apparatus body, or heating portion 30, is not necessarily disposed between the second line head 2 and the third line head 3, and may be mounted to a platen opposing the second line head 2. In other words, the heating portion 30 may be disposed anywhere as long as the portion for heating can heat the glittering ink ejected from the second line head 2 to accelerate the evaporation and dispersion of the liquid medium of the glittering ink.

The control board mainly controls the ejection of the inks and controls the transport mechanisms 11 and 12, the irradiation portion 20, and the heating portion 30. Also, the control board can vary the moving speed of the recording medium 10 moved by the transport mechanisms 11 and 12 corresponding to the amount of polymerizable ink or glittering ink ejected. More specifically, when a large amount of polymerizable ink or glittering ink is ejected, the recording medium 10 is moved at a low speed, and when a small amount of polymerizable ink or glittering ink is ejected, the recording medium 10 is moved at a high speed. Alternatively, the moving speed may be varied depending on whether or not the glittering ink is ejected, in such a manner that the recording medium is moved at a low speed when the glittering ink is ejected. In this instance, if the glittering ink is an aqueous or solvent-based ink, the moving speed of the recording medium may be reduced in view of the time for which the glittering ink can dry, because the glittering ink is not dried (cured) as rapidly as the polymerizable ink in many cases.

In the present embodiment, since the first line head 1 is disposed upstream from the second line head 2 in the moving direction of the recording medium 10, a smooth undercoat layer can be formed with the polymerizable ink in the region where an image of the glittering ink will be formed.

In addition, since the third line head 3 is disposed downstream from the first line dead 1 and further from the second line head 2 in the moving direction of the recording medium 10, an image of the coloring ink can be formed on a glittering undercoat layer.

Furthermore, since the glittering ink is aqueous, the dispersion of the particles of the glittering ink can be stabilized.

Also, since the heating portion 30 is disposed downstream from the second line head 2 in the moving direction of the recording medium 10, the solvent remaining in the image can be dried after the glittering ink has been ejected to the recording medium 10.

Furthermore, since the moving speed of the recording medium 10 moved by the transport mechanisms 11 and 12 can be varied according to the amount of polymerizable ink or glittering ink ejected, the time for forming an image can be appropriately controlled.

Moreover, since the irradiation portion 20 is disposed at a position satisfying the relationship R1>R2, the degree of the clogging of nozzles can be reduced in the first line head 1. More specifically, the polymerizable ink attached to the nozzle portion of the first line head 1 can be cured by reflection or leakage of the active energy radiation emitted from the irradiation portion 20. However, by disposing the irradiation portion 20 away from the first line head 1 so as to satisfy the relationship R1>R2, the degree of clogging of nozzles of the first line head 1, which is caused by the curing of the polymerizable ink attached to the nozzle portion, can be reduced.

However, depending on the light source used in the irradiation portion 20 or the structure of the apparatus body, the light source may heat. Consequently, the polymerizable ink attached to the nozzle portion of line head 2 can be rapidly dried and clog the nozzles. In such a case, the degree of the clogging of nozzles can be reduced in the first line head 1 by suppressing the reflection, leakage or the like of the active energy radiation emitted from the irradiation portion 20. Therefore, the irradiation portion 20 may be disposed away from the second line head 2 so as to satisfy the relationship R1<R2. Thus, the degree of the clogging of nozzles can be reduced which is caused by the curing of the glittering ink attached to the nozzle portion.

As described above, the ink jet recording apparatus 100 of the present embodiment ejects a polymerizable ink selectively to the region where a glittering ink will be applied, and cures the polymerizable ink to form an undercoat layer. The undercoat layer acts as a glittering ink receiving layer, so that the particles of the glittering pigment can be evenly oriented on the recording medium 10 and thus exhibits high glitter. Consequently, high-definition, high-glitter color images (metallic color images) can be formed on a recording medium 10 even if the recording medium 10 is an ink-non-absorbent or ink-low-absorbent medium, a medium having an arithmetic average roughness Ra of 20 μm or more, cloth, plain paper, or a medium having a pigment layer containing a pigment having an average particle size of 200 nm or more. Also, since the ink jet heads are line heads, the ink jet recording apparatus can perform large-size recording and can form a high-definition, high-glitter color image at a high speed.

### 5.2.2. Second Embodiment

FIGS. 2A and 2B are schematic views of ink jet recording apparatuses 200 and 201 according to a second embodiment. The ink jet recording apparatus 200 includes the structure of the first embodiment, and this structure is further provided with a fourth line head 4, as shown in FIG. 2A. The ink jet recording apparatus 200 has the same structure as in the first embodiment except that the fourth line head 4 is disposed upstream from the first line head 1 in the moving direction of the recording medium 10. The fourth line head 4 has many ejection nozzles aligned in a line in a direction intersecting the X direction. The fourth line head 4 ejects a white-type ink delivered from the ink container.

In this structure, since the fourth line head 4 is disposed upstream from the first line head 1 in the moving direction of the recording medium 10, the layer of the polymerizable ink is formed on the white-type ink ejected from the fourth line head 4.

Glittering images tend to deteriorate in lightness due to metal pieces (for example, aluminum pieces) or metal particles (for example, silver particles) of the glittering pigment in the glittering ink. The lightness of such a glittering image can be increased by forming a glittering image over a white undercoat (undercoat image). However, the white-type pigment contained in the white-type ink of an undercoat is often as coarse as an average particle size of 200 nm or more. In such a case, a desired glitter (glossiness) cannot be produced.

On the other hand, in the ink jet recording apparatus 200 of the present embodiment, the undercoat layer is formed by ejecting a polymerizable ink on a white-type ink, and thus can reduce the influence of the coarse particles of the white-type pigment. In other words, an image of the glittering ink can be formed on a smoother undercoat layer with a high lightness. Thus, the ink jet recording apparatus 200 can perform large-size recording and can form a high-definition, high-lightness, high-glitter image at a high speed.

In an ink jet recording apparatus 201, the third and fourth line heads 3 and 4 are interchanged with respect to the structure of the ink jet recording apparatus 200, as shown in FIG. 2B. More specifically, the third line head 3 is disposed upstream from the first line head 1 in the moving direction of the recording medium 10, and the fourth line head 4 is disposed downstream from the second line head 2 in the moving direction of the recording medium 10.

In this structure, in which the third, the first, the second and the fourth line head 3, 1, 2 and 4 are arranged in that order in the moving direction of the recording medium 10, inks are ejected onto the recording medium 10 in the order of the coloring ink, the polymerizable ink, the glittering ink and the white-type ink. Accordingly, by using an optically transparent recording medium 10, a high-definition, high-lightness, high-glitter color image that can be viewed from the rear side of the recording medium 10 or the recording medium side can be formed. In this instance, the white undercoat (undercoat image) acts as an undercoat for the image viewed from the recording medium side.

The ink jet recording apparatuses 200 and 201 may be independent apparatuses of each other, or may be different arrangements provided by a single apparatus in which the third and fourth line heads 3 and 4 can be easily interchanged. The latter case can provide two arrangements: a first arrangement in which the third line head 3 is disposed downstream from the second line head 2 in the moving direction of the recording medium 10, and the fourth line head 4 is disposed upstream from the first line head 1 in the moving direction of the recording medium 10; and a second arrangement in which the third line head 3 is disposed upstream from the first line head 1 in the moving direction of the recording medium 10, and the fourth line head 4 is disposed downstream from the second line head 2 in the moving direction of the recording medium 10.

### 5.2.3. Third Embodiment

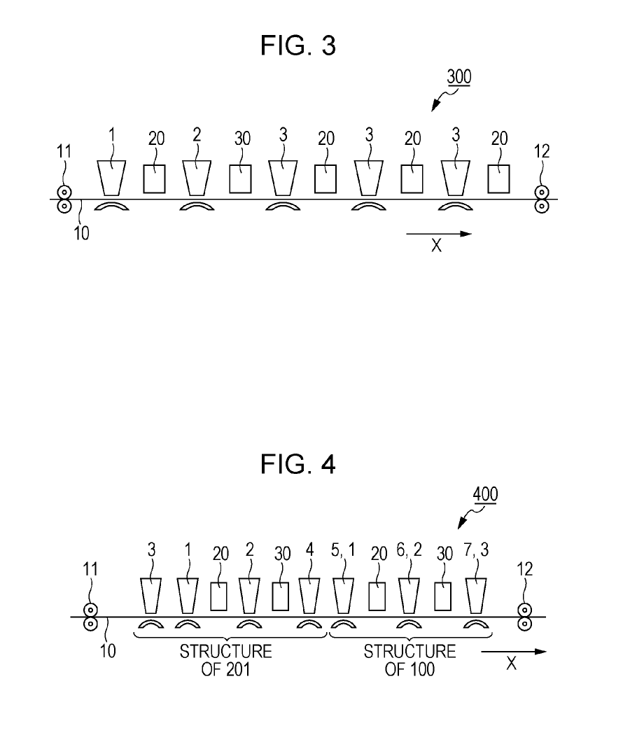

FIG. 3 is a schematic view of an ink jet recording apparatus 300 according to a third embodiment. The structure of the present embodiment is suitable for forming an image with a coloring ink containing an active energy radiation-polymerizable compound. In the ink jet recording apparatus 300, as shown in FIG. 3, two additional third line heads 3 are disposed downstream from the structure of the first embodiment in the moving direction of the recording medium 10. Each of the third line heads 3, including the line head 3 originally disposed in the structure of the first embodiment, is provided with an irradiation portion 20 downstream therefrom. The number of sets of the third line head 3 and the corresponding irradiation portion 20 disposed downstream of the third line head 3 is not limited to three as above, and may be increased according to the type of the coloring ink used. When the glittering ink substantially does not contain a polymerizable ink, the heating portion 30 need not be provided because the layer formed with the polymerizable ink can act as an undercoat to absorb the glittering ink to some extent. In this instance, the irradiation portion 20 and the heating portion 30 are not disposed between the second and third line heads 2 and 3.

In this structure, the irradiation portions 20 disposed downstream from the respective third line heads 3 in the moving direction of the recording medium 10 irradiate the coloring ink containing an active energy radiation-polymerizable compound with active energy radiation every time the coloring ink is ejected, and thus cure the coloring ink. The ink jet recording apparatus thus can from satisfactory images not exhibiting bleeding even when coloring inks are ejected onto one another, and, thus, can provide superior glittering images.

### 5.2.4. Fourth Embodiment

FIG. 4 is a schematic view of an ink jet recording apparatus 400 according to a fourth embodiment. In the ink jet recording apparatus 400, line heads 5 to 7, an irradiation portion 20 and a heating portion 30 are provided downstream from the structure of the ink jet recording apparatus 201 of the second embodiment in the moving direction of the recording medium 10.

The line heads 5 to 7 are substantially the same as the first to third line heads 1 to 3, as will be described below. Each of the line heads 5 to 7 has many ejection nozzles aligned in a line in a direction intersecting the X direction. The line heads 5, 6 and 7 are arranged in that order in the direction in which the recording medium 10 is moved. The Line head 5, or the first line head 5, ejects a polymerizable ink delivered from the ink container. The line head 6, or the second line head, ejects a glittering ink delivered from the ink container. The line head 7, or the third line head, ejects a coloring ink delivered from the ink container.

The additional irradiation portion 20 is disposed between the first line head 5 and the second line head 6, and thus irradiates the polymerizable ink ejected from the first line head 5 with active energy radiation. The additional heating portion 30 is disposed between the second line head 6 and the third line head 7, and thus heats the glittering ink ejected from the second line head 6 to accelerate the evaporation and dispersion of the glittering ink.

In other words, the ink jet recording apparatus 400 includes the structure of the ink jet recording apparatus 201, and the structure of the ink jet recording apparatus 100 is added downstream from the structure of the ink jet recording apparatus 201 in the moving direction of the recording medium 10. However, the transport mechanisms 11 and 12 are respectively disposed only upstream and downstream of the arrangement.

Thus, the ink jet recording apparatus 400 has both advantages of the ink jet recording apparatus 100 and the ink jet recording apparatus 201. Accordingly, by using an optically transparent recording medium 10, a high-definition, high-lightness, high-glitter color image that can be viewed from both sides of the optically transparent recording medium can be formed.

### 5.2.5. Fifth Embodiment

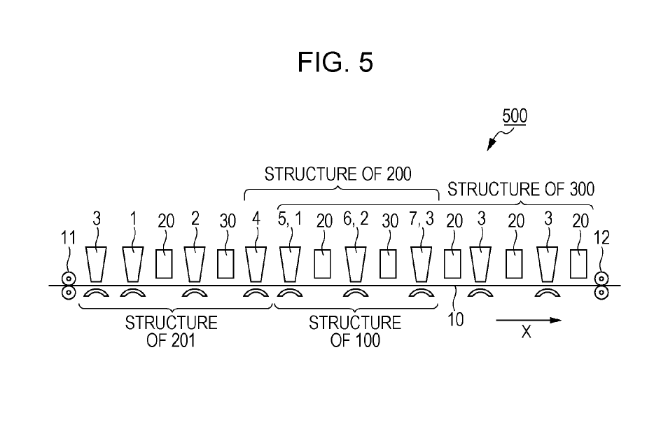

FIG. 5 is a schematic view of an ink jet recording apparatus 500 according to a fifth embodiment. This embodiment has a combination of the structures of the first to fourth embodiments. More specifically, the structure of the present embodiment includes the structure of the ink jet recording apparatus 201 of the second embodiment, and the structure of the ink jet recording apparatus 300 of the third embodiment is added downstream from the structure of the ink jet recording apparatus 201 in the moving direction of the recording medium 10. However, the transport mechanisms 11 and 12 are respectively disposed only upstream and downstream of the arrangement. The structure of this arrangement also includes the structure of the ink jet recording apparatus 100 of the first embodiment and the structure of the ink jet recording apparatus 200 of the second embodiment, as shown in FIG. 5.

This structure has the advantages of the ink jet recording apparatuses of the first to fourth embodiments.

### 5.3. Preparation of Recorded Article

Examples of recorded articles will now be described in which recorded articles were prepared by a temporarily prepared ink jet recording apparatus 500, using different recording media, inks and irradiation energies.

### 5.3.1. Examples 1 to 11

An undercoat layer having a predetermined pattern was formed on each of the recording media shown in Table 2 with the polymerizable ink shown in Table 1 at a predetermined duty. The polymerizable ink was irradiated at an energy shown in Table 2. The irradiation at the shown energy was performed for each 100%-duty recording. Then, the glittering ink was ejected onto the undercoat layer of the polymerizable ink at a duty shown in Table 2. The duty of 200% means that 100%-duty recording was performed twice.

### 5.3.2. Example 12

In Example 12, an undercoat layer having a predetermined pattern was formed on the recording medium shown in Table 2 with the polymerizable ink shown in Table 1 at a predetermined duty. Then, the glittering ink was applied at a duty shown in Table 2. Finally, irradiation was performed at the energy shown in Table 2. The irradiation at the shown energy was performed for each 100%-duty recording.

### 5.3.3. Example 13

In Example 13, recording was performed on the recording medium shown in Table 2 with the white-type ink shown above at a duty of 100%. Then, a predetermined pattern was formed with the polymerizable ink shown in Table 1 at the predetermined duty shown in Table 2. Subsequently, irradiation was performed at the energy shown in Table 2. The irradiation at the shown energy was performed for each 100%-duty recording. Finally, the glittering ink was applied at a duty shown in Table 2.

### 5.3.4. Comparative Examples 1 to 4

An image having a predetermined pattern was formed on the recording medium shown in Table 2 by applying the glittering ink at a duty shown in Table 2.

### 5.3.5. Comparative Example 5

In Comparative Example 5, recording was performed in the same manner as in Example 13 except that the polymerizable ink was not used and that irradiation was not performed.

The term “duty” mentioned herein is calculated from the following equation:

Duty(%)=number of recorded dots in practice/(vertical resolution×horizontal resolution)×100

(In the equation, the “number of recorded dots in practice” refers to the number of dots actually recorded per unit area, and the “vertical resolution” and the “horizontal resolution” each refer to a resolution per unit length.)

TABLE 2

| | | | | Polymerizable | Glittering | | |
|---|---|---|---|---|---|---|---|
| | | | Polymerizable | ink | ink | | |
| | | | ink ejection | irradiation | ejection | | |
| | | | amount, | energy | amount, | 60° | |
| | Recording medium | | Duty (%) | (mJ/cm²) | Duty (%) | glossiness | Evaluation |
| Example 1 | Plain paper | 55PW8R | 100 | 200 | 80 | 11 | D |
| | | | (=1.1 mg/inch²) | | (=7 mg/inch²) | | |
| Example 2 | | | 300 | 200 | 80 | 346 | B |
| Example 3 | Coat pater | NP Coat | 100 | 200 | 80 | 381 | B |
| Example 4 | | | 100 | 300 | 80 | 394 | B |
| Example 5 | Cast-coated | O mirror | 100 | 85.8 | 80 | 376 | B |
| Example 6 | paper | | 200 | 85.8 | 80 | 365 | B |
| Example 7 | | | 100 | 100 | 80 | 377 | B |
| Example 8 | | | 100 | 200 | 80 | 408 | A |
| Example 9 | | | 100 | 300 | 80 | 416 | A |
| Example 10 | Film | YUPO80 | 100 | 200 | 80 | 414 | A |
| Example 11 | (PP Synthetic | | 100 | 300 | 80 | 411 | A |
| | paper) | | | | | | |
| Example 12 | Plain paper | 55PW8R | 300 | 200 | 80 | 148 | C |
| Example 13 | | | 300 | 200 | 80 | 372 | B |
| Comparative | Plain paper | 55PW8R | 0 | 0 | 80 | 5 | E |
| Example 1 | | | | | | | |
| Comparative | Coat pater | NP Coat | 0 | 0 | 80 | 95 | D |
| Example 2 | | | | | | | |
| Comparative | Cast-coated | O mirror | 0 | 0 | 80 | 287 | C |
| Example 3 | paper | | | | | | |
| Comparative | Film | YUPO80 | 0 | 0 | 80 | 31 | D |
| Example 4 | (PP Synthetic | | | | | | |
| | paper) | | | | | | |
| Comparative | Plain paper | 55PW8R | 0 | 0 | 80 | 72 | D |
| Example 5 | | | | | | | |

### 5.4. Glossiness

The record surfaces of the recorded articles of the Examples and Comparative Examples were measured for glossiness at a tilt angle of 60° with a glossmeter (MINOLTA MULTI GLOSS 268), and were evaluated according to the following criteria. The results are shown in Table 2 together.

A: 60° glossiness is 400 or more.

B: 60° glossiness is 300 or more and less than 400.

C: 60° glossiness is 100 or more and less than 300.

D: 60° glossiness is 10 or more and less than 100.

E: 60° glossiness is less than 10.

What is claimed is:

1. An ink jet recording apparatus comprising:
a first line head that ejects a polymerizable ink onto a recording medium to form an undercoat layer, the polymerizable ink containing an active energy radiation-polymerizable compound, but substantially not containing a coloring agent;
a second line head that ejects a glittering ink containing a glittering pigment onto the undercoat layer to form a glittering image;
a transport mechanism that transports the recording medium in a moving direction; and
an irradiation portion that emits active energy radiation,
wherein the first line head is disposed upstream from the second line head in the moving direction.

2. The ink jet recording apparatus according to claim 1, further comprising a third line head that ejects a coloring ink containing a coloring agent to form a color image, the third line head being disposed downstream from the second line head in the moving direction.

3. The ink jet recording apparatus according to claim 1, further comprising a fourth line head that ejects an undercoat ink containing a pigment having an average particle size of 200 nm or more to form an undercoat image, the fourth line head being disposed upstream from the first line head in the moving direction.

4. The ink jet recording apparatus according to claim 1, further comprising:
a third line head that ejects a coloring ink containing a coloring agent to form a color image, the third line head being disposed downstream from the second line head in the moving direction; and
a fourth line head that ejects an undercoat ink containing a pigment having an average particle size of 200 nm or more to form an undercoat image, the fourth line head being disposed upstream from the first line head in the moving direction.

5. The ink jet recording apparatus according to claim 1, further comprising:
a third line head that ejects a coloring ink containing a coloring agent, the third line head being disposed upstream from the first line head in the moving direction; and
a fourth line head that ejects an undercoat ink containing a pigment having an average particle size of 200 nm or more to form an undercoat image, the fourth line head being disposed downstream from the second line head in the moving direction.

6. The ink jet recording apparatus according to claim 1, further comprising:
a third line head that ejects a coloring ink containing a coloring agent to form a color image; and
a fourth line head that ejects an undercoat ink containing a pigment having an average particle size of 200 nm or more to form an undercoat image,
wherein the third line head and the fourth line head are interchangeable so as to form either a first arrangement in which the third line head is disposed downstream from the second line head in the moving direction and the fourth line head is disposed upstream from the first line head in the moving direction, or a second arrangement in which the third line head is disposed upstream from the first line head in the moving direction and the fourth line head is disposed downstream from the second line head in the moving direction.

7. The ink jet recording apparatus according to claim 1, wherein the glittering ink is an aqueous or solvent-based ink.

8. The ink jet recording apparatus according to claim 1, further comprising a heating portion at a position opposing the second line head with the recording medium therebetween or downstream from the second line head in the moving direction.

9. The ink jet recording apparatus according to claim 2, wherein the coloring ink further contains an active energy radiation-polymerizable compound, and the glittering ink is an aqueous or solvent-based ink, and wherein the irradiation portion is disposed downstream from the third line head in the moving direction.

10. The ink jet recording apparatus according to claim 1, wherein the moving speed of the recording medium moved by the transport mechanism is varied according to the amount of the polymerizable ink or glittering ink ejected.

11. The ink jet recording apparatus according to claim 1, wherein the irradiation portion is disposed so that the distance R1 between the first line head and the irradiation portion and the distance R2 between the second line head and the irradiation portion satisfy the relationship R1>R2.

12. The ink jet recording apparatus according to claim 1, wherein the irradiation portion is disposed so that the distance R1 between the first line head and the irradiation portion and the distance R2 between the second line head and the irradiation portion satisfy the relationship R1<R2.

13. A recorded article produced with the ink jet recording apparatus as set forth in claim 1.

14. A recorded article produced with the ink jet recording apparatus as set forth in claim 2.

15. A recorded article produced with the ink jet recording apparatus as set forth in claim 3.

16. A recorded article produced with the ink jet recording apparatus as set forth in claim 4.

17. A recorded article produced with the ink jet recording apparatus as set forth in claim 5.

18. A recorded article produced with the ink jet recording apparatus as set forth in claim 6.

19. A recorded article produced with the ink jet recording apparatus as set forth in claim 7.

20. A recorded article produced with the ink jet recording apparatus as set forth in claim 8.
